(19) United States
(12) Patent Application Publication
(10) Pub. No.: US 2022/0301754 A1
(43) Pub. Date: Sep. 22, 2022

(54) R-T-B SERIES PERMANENT MAGNET MATERIAL, RAW MATERIAL COMPOSITION, PREPARATION METHOD AND APPLICATION

(71) Applicants: XIAMEN TUNGSTEN CO., LTD., Fujian (CN); FUJIAN CHANGTING GOLDEN DRAGON RARE-EARTH CO., LTD, Fujian (CN)

(72) Inventors: Qin LAN, Fujian (CN); Jiaying HUANG, Fujian (CN); Dakun CHEN, Fujian (CN)

(21) Appl. No.: 17/635,156

(22) PCT Filed: Jul. 7, 2020
(86) PCT No.: PCT/CN2020/100577

§ 371 Date: Feb. 14, 2022

(30) Foreign Application Priority Data
Dec. 9, 2019 (CN) 2019 11253954.2

(51) Int. Cl. H01F 1/057; C22C 38/00; C22C 38/06; C22C 38/10; C22C 38/16; C22C 38/12

(52) U.S. Cl. CPC H01F 1/0577; C22C 38/005; C22C 38/06; C22C 38/10; C22C 38/002; C22C 38/16; C22C 38/12; H01F 41/0266

(57) ABSTRACT

An R-T-B series permanent magnet material, a raw material composition, a preparation method, and an application. An R-T-B series permanent magnet material I comprises R, T and X, which satisfy the following relational formula: (1) the atomic ratio of (Fe+Co)/B is 12.5-13.5; (2) the atomic ratio of B/X is 2.7-4.1; and X is one or more among Al, Ga and Cu. The permanent magnet material I comprises R₂T₁₄B primary phase crystalline particles, and a secondary grain boundary phase and a rare earth rich phase between two adjacent R₂T₁₄B primary phase crystalline particles. The secondary grain boundary phase and rare earth rich phase comprise phases composed of R₆T₁₃X. R₆T₁₃X phases are formed in the R-T-B series permanent magnet material I, so that Hcj and mechanical performance can be synchronously improved.

### TECHNICAL FIELD

The present disclosure relates to an R-T-B series permanent magnet material, a raw material composition, a preparation method, and an application thereof.

### BACKGROUND

Permanent magnet materials have been developed as key materials to support electronic devices, and the development is in the direction of high magnetic energy product and high coercivity. R-T-B series permanent magnet material (where R is at least one of the rare earth elements) are known to have the highest performance among permanent magnets, and are used in various motors and home appliances such as voice coil motors (VCM) for hard disk drives, motors for electric vehicles (EV, HV, PHV etc.), and motors for industrial equipment.

In the prior art, NdFeB with a conventional B content cannot generate an R₆-T₁₃-X phase, and the magnetic performance is relatively poor. Under the premise of a similar formula system, if the B content in the NdFeB composition is reduced (the B content is about 0.93 wt. % or less) and Ga, Cu, Al, Si, and Ti are added to generate an R₆-T₁₃-X phase (X includes Ga, Cu, Al, Si, etc.) to improve the performance of a magnet, since the B content is reduced, impurity phases such as R₂T₁₇ and TiBx are easily formed in the magnet, thereby causing the mechanical properties of the magnet to decrease and the material to be more brittle, which is not conducive to processing and use in high-speed motors.

Therefore, there is an urgent need for an R-T-B series permanent magnet material that has a guaranteed magnetic performance without compromised mechanical properties.

### Content of the Present Invention

The technical problem to be solved by the present disclosure is to provide an R-T-B series permanent magnet material, a raw material composition, a preparation method, and the use thereof, in order to overcome the deficiency in the prior art that when the magnetic performance of an R-T-B series permanent magnet material is improved by generating an R₆-T₁₃-X phase, the mechanical properties of the magnet decreases.

The present disclosure solves the above-mentioned technical problem by means of the following technical solutions:

The present disclosure provides R-T-B series permanent magnet material I, comprising R, T and X, wherein

R is a rare earth element including at least Nd, and R includes RH, wherein RH is a heavy rare earth element, and
RH includes at least Dy and/or Tb;
T includes at least Fe;
X is one or more of Al, Ga and Cu, and X necessarily includes Al;
R-T-B series permanent magnet material I satisfies the following relational expressions:
(1) an atomic ratio of (Fe+Co)/B of 12.5-13.5;
(2) an atomic ratio of B/X of 2.7-4.1;
R-T-B series permanent magnet material I comprises R₂T₁₄B main phase crystalline grains, a two-grain boundary phase between two adjacent R₂T₁₄B main phase crystalline grains, and a rare-earth-rich phase, wherein the two-grain boundary phase and the rare-earth-rich phase comprise a phase composed of R₆T₁₃X.

In the present disclosure, the above-mentioned relational expressions (1) and (2) are established based on the fact that the inventors have found during the research on the generation of the R₆-T₁₃-X phase that a region rich in B and poor in X (X is one or more of Al, Ga and Cu, and X necessarily includes Al) was present in a magnet containing the R₆-T₁₃-X phase, and it was thus inferred that B and X had a certain corresponding relationship, wherein when the content of B was small, the content of the rare earth was relatively high, and the proportion of Fe also changed. Therefore, in the present disclosure, by increasing the content of X and adjusting the amount of the rare earth, the proportions of Fe and B are changed, so that the R₆-T₁₃-X phase (X is one or more of Al, Ga, and Cu) can also be generated only with a conventional B content.

In the present disclosure, T includes Fe and Co.

In the present disclosure, preferably, in the R₆-T₁₃-X phase, X is Al and Cu, e.g. Nd is 27.9 at %, Dy is 1.85 at %, Fe is 64.25 at %, Co is 0.77 at %, Al is 4.63 at %, and Cu is 0.42 at %, wherein at % refers to the percentage of the atomic content of each element in the R-T-B series permanent magnet material.

In the present disclosure, the atomic ratio of (Fe+Co)/B is preferably 12.8-13.39, e.g. 12.5, 12.86, 12.88, 12.89, 12.9 or 13.9.

In the present disclosure, the atomic ratio of B/X is preferably 2.8-4, e.g. 2.8, 2.9, 3.2, 3.6, 3.8, 3.9 or 4.

In the present disclosure, preferably, R-T-B series permanent magnet material I, comprises, by mass percentage,

31.0-32.5 wt. % of R, R includes RH,

### 0.20-0.50 wt. % of Cu,

### 0.40-0.80 wt. % of Al,

### 0-0.30 wt. % of Ga,

### 0.10-0.25 wt. % of Nb,

### 0.5-2.0 wt. % of Co,

### 0.97-1.03 wt. % of B,

wherein wt. % refers to the mass percentage relative to R-T-B series permanent magnet material I;
R is a rare earth element including at least Nd;
RH is a heavy rare earth element, and RH includes at least Dy and/or Tb; and
the balance is Fe and inevitable impurities.

R may also include rare earth elements conventional in the art, e.g. Pr.

The range of the content of R is preferably 31.5-32.5 wt. %, e.g. 31 wt. %, 31.5 wt. %, 32 wt. % or 32.5 wt. %, wherein wt. % refers to the mass percentage relative to R-T-B series permanent magnet material I.

The range of the content of RH is preferably 0.8-2.2 wt. %, e.g. 0.8 wt. %, 1.5 wt. % or 2 wt. %, wherein wt. % refers to the mass percentage relative to R-T-B series permanent magnet material I.

The range of the content of Cu is preferably 0.2-0.4 wt. % or 0.3-0.5 wt. %, e.g. 0.2 wt. %, 0.3 wt. %, 0.35 wt. %, 0.4 wt. %, 0.45 wt. % or 0.5 wt. %, wherein wt. % refers to the mass percentage relative to R-T-B series permanent magnet material I.

The range of the content of Al is preferably 0.4-0.6 wt. % or 0.5-0.8 wt. %, e.g. 0.4 wt. %, 0.5 wt. %, 0.51 wt. %, 0.6 wt. %, 0.65 wt. %, 0.7 wt. % or 0.8 wt. %, wherein wt. % refers to the mass percentage relative to R-T-B series permanent magnet material I.

The range of the content of Ga is preferably 0 wt. % or 0.3 wt. %, wherein wt. % refers to the mass percentage relative to R-T-B series permanent magnet material I.

The range of the content of Nb is preferably 0.1-0.2 wt. % or 0.12-0.25 wt. %, e.g. 0.1 wt. %, 0.12 wt. %, 0.15 wt. %, 0.2 wt. % or 0.25 wt. %, wherein wt. % refers to the mass percentage relative to R-T-B series permanent magnet material I.

The range of the content of Co is preferably 0.5-1.5 wt. % or 1-2 wt. %, e.g. 0.5 wt. %, 1 wt. %, 1.2 wt. % or 1.5 wt. %, wherein wt. % refers to the mass percentage relative to R-T-B series permanent magnet material I.

The range of the content of B is preferably 0.97-1 wt. % or 0.99-1.03 wt. %, e.g. 0.97 wt. %, 0.98 wt. %, 0.99 wt. %, 1 wt. % or 1.03 wt. %, wherein wt. % refers to the mass percentage relative to R-T-B series permanent magnet material I.

In a preferred embodiment of the present disclosure, R-T-B series permanent magnet material I comprises, by mass percentage, 31.0-32.5 wt. % of R; 0.8-2.2 wt. % of RH; 0.30-0.50 wt. % of Cu; 0.50-0.70 wt. % of Al; 0.10-0.25 wt. % of Nb; 0.5-2.0 wt. % of Co; and 0.97-1.03 wt. % of B; wherein wt. % refers to the mass percentage relative to R-T-B series permanent magnet material I; R is a rare earth element including at least Nd; RH is a heavy rare earth element; RH includes at least Dy and/or Tb; and the balance is Fe and inevitable impurities.

In a preferred embodiment of the present disclosure, R-T-B series permanent magnet material I comprises, by mass percentage, 31.5-32.5 wt. % of R, 0.8-2.2 wt. % of RH; 0.2-0.4 wt. % of Cu; 0.4-0.6 wt. % of Al; 0-0.3 wt. % of Ga; 0.1-0.2 wt. % of Nb; 0.5-1.5 wt. % of Co; 0.97-1 wt. % of B, wherein wt. % refers to the mass percentage relative to R-T-B series permanent magnet material I; R is a rare earth element including at least Nd; RH is a heavy rare earth element; RH includes at least Dy and/or Tb; and the balance is Fe and inevitable impurities.

In a preferred embodiment of the present disclosure, R-T-B series permanent magnet material I comprises, by mass percentage, 31 wt. % of PrNd, 0.8 wt. % of Tb, 0.3 wt. % of Cu, 0.5 wt. % of Al, 0.1 wt. % of Nb, 0.5 wt. % of Co, and 0.97 wt. % of B, wherein wt. % refers to the mass percentage relative to R-T-B series permanent magnet material I.

In a preferred embodiment of the present disclosure, R-T-B series permanent magnet material I comprises, by mass percentage, 31 wt. % of PrNd, 1.5 wt. % of Dy, 0.5 wt. % of Cu, 0.7 wt. % of Al, 0.25 wt. % of Nb, 0.5 wt. % of Co, 1.03 wt. % of B, wherein wt. % refers to the mass percentage relative to R-T-B series permanent magnet material I.

In a preferred embodiment of the present disclosure, R-T-B series permanent magnet material I comprises, by mass percentage, 32 wt. % of PrNd, 2 wt. % of Dy, 0.4 wt. % of Cu, 0.6 wt. % of Al, 0.2 wt. % of Nb, 1 wt. % of Co, and 0.99 wt. % of B, wherein wt. % refers to the mass percentage relative to R-T-B series permanent magnet material I.

In a preferred embodiment of the present disclosure, R-T-B series permanent magnet material I comprises, by mass percentage, 31.5 wt. % of PrNd, 1.5 wt. % of Dy, 0.35 wt. % of Cu, 0.51 wt. % of Al, 0.15 wt. % of Nb, 1.5 wt. % of Co, and 1 wt. % of B, wherein wt. % refers to the mass percentage relative to R-T-B series permanent magnet material I.

In a preferred embodiment of the present disclosure, R-T-B series permanent magnet material I comprises, by mass percentage, 32.5 wt. % of Nd, 2 wt. % of Dy, 0.45 wt. % of Cu, 0.65 wt. % of Al, 0.12 wt. % of Nb, 1.2 wt. % of Co, and 0.98 wt. % of B, wherein wt. % refers to the mass percentage relative to R-T-B series permanent magnet material I.

In a preferred embodiment of the present disclosure, R-T-B series permanent magnet material I comprises, by mass percentage, 32 wt. % of PrNd, 2 wt. % of Dy, 0.2 wt. % of Cu, 0.6 wt. % of Al, 0.2 wt. % of Nb, 1 wt. % of Co, and 0.99 wt. % of B, wherein wt. % refers to the mass percentage relative to R-T-B series permanent magnet material I.

In a preferred embodiment of the present disclosure, R-T-B series permanent magnet material I comprises, by mass percentage, 32 wt. % of PrNd, 2 wt. % of Dy, 0.5 wt. % of Cu, 0.4 wt. % of Al, 0.2 wt. % of Nb, 1 wt. % of Co, and 0.99 wt. % of B, wherein wt. % refers to the mass percentage relative to R-T-B series permanent magnet material I.

In a preferred embodiment of the present disclosure, R-T-B series permanent magnet material I comprises, by mass percentage, 32 wt. % of PrNd, 2 wt. % of Dy, 0.2 wt. % of Cu, 0.8 wt. % of Al, 0.2 wt. % of Nb, 1 wt. % of Co, and 0.99 wt. % of B, wherein wt. % refers to the mass percentage relative to R-T-B series permanent magnet material I.

In a preferred embodiment of the present disclosure, R-T-B series permanent magnet material I comprises, by mass percentage, 32 wt. % of PrNd, 2 wt. % of Dy, 0.4 wt. % of Cu, 0.4 wt. % of Al, 0.3 wt. % of Ga, 0.2 wt. % of Nb, 1 wt. % of Co, and 0.99 wt. % of B, wherein wt. % refers to the mass percentage relative to R-T-B series permanent magnet material I.

The present disclosure further provides R-T-B series permanent magnet material II, comprising R, T and X, wherein

R is a rare earth element including at least Nd, and R includes RH, wherein RH is a heavy rare earth element, and
RH includes at least Dy and/or Tb;
T includes at least Fe;
X is one or more of Al, Ga and Cu, and X necessarily includes Al;
R-T-B series permanent magnet material II satisfies the following relational expressions:
(1) an atomic ratio of (Fe+Co)/B of 12.5-13.7;
(2) an atomic ratio of B/X of 2.8-4.0.

In the present disclosure, preferably, T includes Fe and Co.

In the present disclosure, the atomic ratio of (Fe+Co)/B is preferably 12.9-13, e.g. 12.94, 12.95, 12.96, 12.98, 12.99 or 13.

In the present disclosure, the atomic ratio of B/X is preferably 2.9-3.9, e.g. 3.2, 3.6 or 3.8.

In the present disclosure, preferably, R-T-B series permanent magnet material II comprises, by mass percentage, the following components:

30.5-32 wt. % of R, R includes RH,

### 0.20-0.50 wt. % of Cu,

### 0.40-0.80 wt. % of Al,

### 0-0.30 wt. % of Ga,

### 0.10-0.25 wt. % of Nb,

### 0.5-2.0 wt. % of Co,

### 0.97-1.03 wt. % of B,

wherein wt. % refers to the mass percentage relative to R-T-B series permanent magnet material II;
R is a rare earth element including at least Nd;
RH is a heavy rare earth element, and RH includes at least Dy and/or Tb;
the balance is Fe and inevitable impurities.

R may also include rare earth elements conventional in the art, e.g. Pr.

The range of the content of R is preferably 31-32 wt. %, e.g. 31 wt. %, 31.5 wt. %, or 32 wt. %, wherein wt. % refers to the mass percentage relative to R-T-B series permanent magnet material II.

The range of the content of RH is preferably 0.3-1.7 wt. %, e.g. 0.3 wt. %, 1 wt. % or 1.5 wt. %, wherein wt. % refers to the mass percentage relative to R-T-B series permanent magnet material II.

The range of the content of Cu is preferably 0.2-0.4 wt. % or 0.3-0.5 wt. %, e.g. 0.2 wt. %, 0.3 wt. %, 0.35 wt. %, 0.4 wt. %, 0.45 wt. % or 0.5 wt. %, wherein wt. % refers to the mass percentage relative to R-T-B series permanent magnet material II.

The range of the content of Al is preferably 0.4-0.6 wt. % or 0.5-0.8 wt. %, e.g. 0.4 wt. %, 0.5 wt. %, 0.51 wt. %, 0.6 wt. %, 0.65 wt. %, 0.7 wt. % or 0.8 wt. %, wherein wt. % refers to the mass percentage relative to R-T-B series permanent magnet material II.

The range of the content of Ga is preferably 0 wt. % or 0.3 wt. %, wherein wt. % refers to the mass percentage relative to R-T-B series permanent magnet material II.

The range of the content of Nb is preferably 0.1-0.2 wt. % or 0.12-0.25 wt. %, e.g. 0.1 wt. %, 0.12 wt. %, 0.15 wt. %, 0.2 wt. % or 0.25 wt. %, wherein wt. % refers to the mass percentage relative to R-T-B series permanent magnet material II.

The range of the content of Co is preferably 0.5-1.5 wt. % or 1-2 wt. %, e.g. 0.5 wt. %, 1 wt. %, 1.2 wt. % or 1.5 wt. %, wherein wt. % refers to the mass percentage relative to R-T-B series permanent magnet material II.

The range of the content of B is preferably 0.97-1 wt. % or 0.99-1.03 wt. %, e.g. 0.97 wt. %, 0.98 wt. %, 0.99 wt. %, 1 wt. % or 1.03 wt. %, wherein wt. % refers to the mass percentage relative to R-T-B series permanent magnet material II.

In a preferred embodiment of the present disclosure, R-T-B series permanent magnet material II comprises, by mass percentage, 30.5-32 wt. % of R, 0.3-1.7 wt. % of RH, 0.30-0.50 wt. % of Cu, 0.50-0.70 wt. % of Al, 0.10-0.25 wt. % of Nb, 0.5-2.0 wt. % of Co, and 0.97-1.03 wt. % of B, wherein wt. % refers to the mass percentage relative to R-T-B series permanent magnet material II; R is a rare earth element including at least Nd; RH is a heavy rare earth element; RH includes at least Dy and/or Tb; and the balance is Fe and inevitable impurities.

In a preferred embodiment of the present disclosure, R-T-B series permanent magnet material II comprises, by mass percentage, 31-32 wt. % of R, 0.3-1 wt. % of RH; 0.2-0.4 wt. % of Cu; 0.4-0.6 wt. % of Al; 0-0.3 wt. % of Ga; 0.1-0.2 wt. % of Nb; 0.5-1.5 wt. % of Co; 0.97-1 wt. % of B, wherein wt. % refers to the mass percentage relative to R-T-B series permanent magnet material II; R is a rare earth element including at least Nd; RH is a heavy rare earth element; RH includes at least Dy and/or Tb; and the balance is Fe and inevitable impurities.

In a preferred embodiment of the present disclosure, R-T-B series permanent magnet material II comprises, by mass percentage, 30.5 wt. % of PrNd, 0.3 wt. % of Tb, 0.3 wt. % of Cu, 0.5 wt. % of Al, 0.1 wt. % of Nb, 0.5 wt. % of Co, and 0.97 wt. % of B, wherein wt. % refers to the mass percentage relative to R-T-B series permanent magnet material II.

In a preferred embodiment of the present disclosure, R-T-B series permanent magnet material II comprises, by mass percentage, 30.5 wt. % of PrNd, 1 wt. % of Dy, 0.5 wt. % of Cu, 0.7 wt. % of Al, 0.25 wt. % of Nb, 0.5 wt. % of Co, 1.03 wt. % of B, wherein wt. % refers to the mass percentage relative to R-T-B series permanent magnet material II.

In a preferred embodiment of the present disclosure, R-T-B series permanent magnet material II comprises, by mass percentage, 31.5 wt. % of PrNd, 1.5 wt. % of Dy, 0.4 wt. % of Cu, 0.6 wt. % of Al, 0.2 wt. % of Nb, 1 wt. % of Co, and 0.99 wt. % of B, wherein wt. % refers to the mass percentage relative to R-T-B series permanent magnet material II.

In a preferred embodiment of the present disclosure, R-T-B series permanent magnet material II comprises, by mass percentage, 31 wt. % of PrNd, 1 wt. % of Dy, 0.35 wt. % of Cu, 0.51 wt. % of Al, 0.15 wt. % of Nb, 1.5 wt. % of Co, and 1 wt. % of B, wherein wt. % refers to the mass percentage relative to R-T-B series permanent magnet material II.

In a preferred embodiment of the present disclosure, R-T-B series permanent magnet material II comprises, by mass percentage, 32 wt. % of Nd, 1.5 wt. % of Dy, 0.45 wt. % of Cu, 0.65 wt. % of Al, 0.12 wt. % of Nb, 1.2 wt. % of Co, and 0.98 wt. % of B, wherein wt. % refers to the mass percentage relative to R-T-B series permanent magnet material II.

In a preferred embodiment of the present disclosure, R-T-B series permanent magnet material II comprises, by mass percentage, 31.5 wt. % of PrNd, 1.5 wt. % of Dy, 0.2 wt. % of Cu, 0.6 wt. % of Al, 0.2 wt. % of Nb, 1 wt. % of Co, and 0.99 wt. % of B, wherein wt. % refers to the mass percentage relative to R-T-B series permanent magnet material II.

In a preferred embodiment of the present disclosure, R-T-B series permanent magnet material II comprises, by mass percentage, 31.5 wt. % of PrNd, 1.5 wt. % of Dy, 0.5 wt. % of Cu, 0.4 wt. % of Al, 0.2 wt. % of Nb, 1 wt. % of Co, and 0.99 wt. % of B, wherein wt. % refers to the mass percentage relative to R-T-B series permanent magnet material II.

In a preferred embodiment of the present disclosure, R-T-B series permanent magnet material II comprises, by mass percentage, 31.5 wt. % of PrNd, 1.5 wt. % of Dy, 0.2 wt. % of Cu, 0.8 wt. % of Al, 0.2 wt. % of Nb, 1 wt. % of Co, and 0.99 wt. % of B, wherein wt. % refers to the mass percentage relative to R-T-B series permanent magnet material II.

In a preferred embodiment of the present disclosure, R-T-B series permanent magnet material II comprises, by mass percentage, 31.5 wt. % of PrNd, 1.5 wt. % of Dy, 0.4 wt. % of Cu, 0.4 wt. % of Al, 0.3 wt. % of Ga, 0.2 wt. % of Nb, 1 wt. % of Co, and 0.99 wt. % of B, wherein wt. % refers to the mass percentage relative to R-T-B series permanent magnet material II.

The present disclosure further provides a raw material composition for R-T-B series permanent magnet material II, comprising, by mass percentage, the following components:

30.5-32 wt. % of R, R includes RH,

### 0.20-0.50 wt. % of Cu,

### 0.40-0.80 wt. % of Al,

### 0-0.30 wt. % of Ga,

### 0.10-0.25 wt. % of Nb,

### 0.5-2.0 wt. % of Co,

### 0.97-1.03 wt. % of B,

wherein wt. % refers to the mass percentage relative to the raw material composition for R-T-B series permanent magnet material II;
R is a rare earth element including at least Nd;
RH is a heavy rare earth element, and RH includes at least Dy and/or Tb;
the balance is Fe and inevitable impurities.

In the present disclosure, R may also include rare earth elements conventional in the art, e.g. Pr.

In the present disclosure, the range of the content of R is preferably 31-32 wt. %, e.g. 31 wt. %, 31.5 wt. %, or 32 wt. %, wherein wt. % refers to the mass percentage relative to the raw material composition for R-T-B series permanent magnet material II.

In the present disclosure, the range of the content of RH is preferably 0.3-1.7 wt. %, e.g. 0.3 wt. %, 1 wt. % or 1.5 wt. %, wherein wt. % refers to the mass percentage relative to the raw material composition for R-T-B series permanent magnet material II.

In the present disclosure, the range of the content of Cu is preferably 0.2-0.4 wt. % or 0.3-0.5 wt. %, e.g. 0.2 wt. %, 0.3 wt. %, 0.35 wt. %, 0.4 wt. %, 0.45 wt. % or 0.5 wt. %, wherein wt. % refers to the mass percentage relative to the raw material composition for R-T-B series permanent magnet material II.

In the present disclosure, the range of the content of Al is preferably 0.4-0.6 wt. % or 0.5-0.8 wt. %, e.g. 0.4 wt. %, 0.5 wt. %, 0.51 wt. %, 0.6 wt. %, 0.65 wt. %, 0.7 wt. % or 0.8 wt. %, wherein wt. % refers to the mass percentage relative to the raw material composition for R-T-B series permanent magnet material II.

In the present disclosure, the range of the content of Ga is preferably 0 wt. % or 0.3 wt. %, wherein wt. % refers to the mass percentage relative to the raw material composition for R-T-B series permanent magnet material II.

In the present disclosure, the range of the content of Nb is preferably 0.1-0.2 wt. % or 0.12-0.25 wt. %, e.g. 0.1 wt. %, 0.12 wt. %, 0.15 wt. %, 0.2 wt. % or 0.25 wt. %, wherein wt. % refers to the mass percentage relative to the raw material composition for R-T-B series permanent magnet material II.

In the present disclosure, the range of the content of Co is preferably 0.5-1.5 wt. % or 1-2 wt. %, e.g. 0.5 wt. %, 1 wt. %, 1.2 wt. % or 1.5 wt. %, wherein wt. % refers to the mass percentage relative to the raw material composition for R-T-B series permanent magnet material II.

In the present disclosure, the range of the content of B is preferably 0.97-1 wt. % or 0.99-1.03 wt. %, e.g. 0.97 wt. %, 0.98 wt. %, 0.99 wt. %, 1 wt. % or 1.03 wt. %, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 30.5-32 wt. % of R, 0.3-1.7 wt. % of RH, 0.30-0.50 wt. % of Cu, 0.50-0.70 wt. % of Al, 0.10-0.25 wt. % of Nb, 0.5-2.0 wt. % of Co, and 0.97-1.03 wt. % of B, wherein wt. % refers to the mass percentage of the raw material composition for R-T-B series permanent magnet material II; R is a rare earth element including at least Nd; RH is a heavy rare earth element; RH includes at least Dy and/or Tb; and the balance is Fe and inevitable impurities.

In a preferred embodiment of the present disclosure, the raw material composition for R-T-B series permanent magnet material II comprises, by mass percentage, 31-32 wt. % of R, 0.3-1 wt. % of RH, 0.2-0.4 wt. % of Cu, 0.4-0.6 wt. % of Al, 0-0.3 wt. % of Ga, 0.1-0.2 wt. % of Nb, 0.5-1.5 wt. % of Co, and 0.97-1 wt. % of B, wherein wt. % refers to the mass percentage of the raw material composition for R-T-B series permanent magnet material II; R is a rare earth element including at least Nd; RH is a heavy rare earth element; RH includes at least Dy and/or Tb; and the balance is Fe and inevitable impurities.

In a preferred embodiment of the present disclosure, the raw material composition for R-T-B series permanent magnet material II comprises, by mass percentage, 30.5 wt. % of PrNd, 0.3 wt. % of Tb, 0.3 wt. % of Cu, 0.5 wt. % of Al, 0.1 wt. % of Nb, 0.5 wt. % of Co, and 0.97 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 30.5 wt. % of PrNd, 1 wt. % of Dy, 0.5 wt. % of Cu, 0.7 wt. % of Al, 0.25 wt. % of Nb, 0.5 wt. % of Co, 1.03 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 31.5 wt. % of PrNd, 1.5 wt. % of Dy, 0.4 wt. % of Cu, 0.6 wt. % of Al, 0.2 wt. % of Nb, 1 wt. % of Co, and 0.99 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 31 wt. % of PrNd, 1 wt. % of Dy, 0.35 wt. % of Cu, 0.51 wt. % of Al, 0.15 wt. % of Nb, 1.5 wt. % of Co, and 1 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 32 wt. % of Nd, 1.5 wt. % of Dy, 0.45 wt. % of Cu, 0.65 wt. % of Al, 0.12 wt. % of Nb, 1.2 wt. % of Co, and 0.98 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 31.5 wt. % of PrNd, 1.5 wt. % of Dy, 0.2 wt. % of Cu, 0.6 wt. % of Al, 0.2 wt. % of Nb, 1 wt. % of Co, and 0.99 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 31.5 wt. % of PrNd, 1.5 wt. % of Dy, 0.5 wt. % of Cu, 0.4 wt. % of Al, 0.2 wt. % of Nb, 1 wt. % of Co, and 0.99 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 31.5 wt. % of PrNd, 1.5 wt. % of Dy, 0.2 wt. % of Cu, 0.8 wt. % of Al, 0.2 wt. % of Nb, 1 wt. % of Co, and 0.99 wt. % of B, wherein wt. % refers to the mass percentage relative to the raw material composition for R-T-B series permanent magnet material II.

In a preferred embodiment of the present disclosure, the raw material composition for R-T-B series permanent magnet material II comprises, by mass percentage, 31.5 wt. % of PrNd, 1.5 wt. % of Dy, 0.4 wt. % of Cu, 0.4 wt. % of Al, 0.3 wt. % of Ga, 0.2 wt. % of Nb, 1 wt. % of Co, and 0.99 wt. % of B, wherein wt. % refers to the mass percentage relative to the raw material composition for R-T-B series permanent magnet material II.

The present disclosure further provides a preparation method for R-T-B series permanent magnet material II, comprising the following step: subjecting a melt of the raw material composition for R-T-B series permanent magnet material II to casting, crushing, pulverization, forming, and sintering.

In the present disclosure, the melt of the raw material composition for R-T-B series permanent magnet material II can be prepared by means of a conventional method in the art, e.g. by smelting in a high-frequency vacuum induction smelting furnace. The degree of vacuum in the smelting furnace may be 5×10⁻² Pa. The smelting temperature may be 1500° C. or less.

In the present disclosure, the casting process may be a conventional casting process in the art, e.g. cooling at a rate of 10² to 10⁴° C./sec in an Ar atmosphere, e.g. in an Ar atmosphere of 5.5×10⁴ Pa.

In the present disclosure, the crushing process may be a conventional crushing process in the art, e.g. hydrogen absorption, dehydrogenation, and cooling treatment.

The hydrogen absorption may be carried out under the condition of a hydrogen pressure of 0.15 MPa.

The dehydrogenation may be carried out under the condition of evacuation while heating.

In the present disclosure, the pulverization process may be a conventional pulverization process in the art, e.g. jet mill pulverization.

Preferably, the pulverization process is carried out in an atmosphere with an oxidizing gas content of 100 ppm or less.

The oxidizing gas refers to oxygen or moisture content.

The pressure in a pulverization chamber for the jet mill pulverization may be 0.38 MPa.

The time for the jet mill pulverization may be 3 hours.

After pulverization, a lubricant, such as zinc stearate, may be added by a conventional means in the art. The lubricant may be added in an amount of 0.10-0.15%, e.g. 0.12%, relative to the weight of the mixed powder.

In the present disclosure, the forming process may be a conventional forming process in the art, e.g. a magnetic field forming method or a hot pressing thermal deformation method.

In the present disclosure, the sintering process may be a conventional sintering process in the art, e.g. preheating, sintering, and cooling under vacuum condition, e.g. in a vacuum of 5×10⁻³ Pa.

The preheating temperature may be 300-600° C. The preheating time may be 1-2 h. Preferably, the preheating is carried out at 300° C. and 600° C., each for 1 h.

The sintering temperature may be a conventional sintering temperature in the art, e.g. 900-1100° C., further 1040° C.

The sintering time may be a conventional sintering time in the art, e.g. 2 h.

Before cooling, Ar gas may be introduced to make the gas pressure reach 0.1 MPa.

The present disclosure further provides R-T-B series permanent magnet material II prepared by the above-mentioned preparation method.

The present disclosure further provides a preparation method for R-T-B series permanent magnet material I, involving subjecting R-T-B series permanent magnet material II to a grain boundary diffusion treatment.

The heavy rare earth element in the grain boundary diffusion treatment includes Dy and/or Tb.

In the present disclosure, the grain boundary diffusion treatment may be carried out according to a conventional process in the art, e.g. Dy vapor diffusion.

The temperature for the diffusion heat treatment may be 800-900° C., e.g. 850° C.

The time for the diffusion heat treatment may be 12-48 h, e.g. 24 h.

After the grain boundary diffusion treatment, a heat treatment may be further carried out. The temperature for the heat treatment may be 450-550° C., e.g. 500° C. The time for the heat treatment may be 3 h.

The present disclosure further provides R-T-B series permanent magnet material I prepared by the above-mentioned preparation method.

The present disclosure further provides an application of the R-T-B series permanent magnet material as an electronic component.

The electronic component may be conventional in the art, e.g. electronic components in motors.

The R-T-B series permanent magnet material may be R-T-B series permanent magnet material I and/or R-T-B series permanent magnet material II mentioned above.

On the basis of conforming to common knowledge in the art, the above-mentioned preferred conditions can be arbitrarily combined to obtain various preferred embodiments of the present disclosure.

The reagents and raw materials used in the present disclosure are all commercially available.

The positive progressive effects of the present disclosure lie in:

(1) The permanent magnet material of the present disclosure maintains good mechanical properties. The flexural strength of an existing low-B permanent magnet is 270-300 MPa, whereas the flexural strength of the permanent magnet material of the present disclosure is 370-402 MPa.

(2) The permanent magnet material of the present disclosure has a good magnetic performance Br≥13.20 kGs, and Hcj≥25.1 kOe, indicating that the Br and Hcj are both improved; in addition, the maximum energy product (abbreviated as BHmax)≥42.5 MGOe.

### BRIEF DESCRIPTION OF THE DRAWINGS

FIG. 1 is an FE-EPMA backscattering image of Example 5.

FIG. 2 is an FE-EPMA backscattering image of Comparative Example 3.

### DETAILED DESCRIPTION OF THE PREFERRED EMBODIMENT

The present disclosure is further described below by way of examples; however, the present disclosure is not limited to the scope of the examples described hereinafter. For the experimental methods in which no specific conditions are specified in the following examples, selections are made according to conventional methods and conditions or according to the product instructions.

The raw material formulas of R-T-B series permanent magnet material II in the examples and comparative examples are as shown in Table 1. In the following table, “I” means that the element is not added, “Br” refers to residual magnetic flux density, “Hcj” refers to intrinsic coercivity, “BHmax” refers to maximum energy product, and “BHH” refers to the sum of BHmax and Hcj.

TABLE 1
Composition of raw material composition for R-T-B series
permanent magnet material II and contents (wt. %)

| No. | R | Nd | PrNd | Tb | Dy | Cu | Al | Ga | Nb | Co | B | Fe |
|---|---|---|---|---|---|---|---|---|---|---|---|---|
| Example 1 | 30.5 | / | 30.2 | 0.3 | / | 0.3 | 0.5 | / | 0.1 | 0.5 | 0.97 | Balance |
| Example 2 | 29.5 | / | 29.5 | / | 1 | 0.5 | 0.7 | / | 0.25 | 0.5 | 1.03 | Balance |
| Example 3 | 30 | / | 30 | / | 1.5 | 0.4 | 0.6 | / | 0.2 | 1 | 0.99 | Balance |
| Example 4 | 30 | / | 30 | / | 1 | 0.35 | 0.51 | / | 0.15 | 1.5 | 1 | Balance |
| Example 5 | 32 | 30.5 | / | / | 1.5 | 0.45 | 0.65 | / | 0.12 | 1.2 | 0.98 | Balance |
| Example 6 | 30 | / | 30 | / | 1.5 | 0.2 | 0.6 | / | 0.2 | 1 | 0.99 | Balance |
| Example 7 | 30 | / | 30 | / | 1.5 | 0.5 | 0.4 | / | 0.2 | 1 | 0.99 | Balance |
| Example 8 | 30 | / | 30 | / | 1.5 | 0.2 | 0.8 | / | 0.2 | 1 | 0.99 | Balance |
| Example 9 | 30 | / | 30 | / | 1.5 | 0.4 | 0.4 | 0.3 | 0.2 | 1 | 0.99 | Balance |
| Comparative | 33.5 | / | 32 | / | 1.5 | 0.3 | 0.8 | / | 0.1 | 0.5 | 1.03 | Balance |
| Example 1 | | | | | | | | | | | | |
| Comparative | 29.5 | / | 28 | / | 1.5 | 0.25 | 0.4 | / | 0.3 | 0.4 | 0.97 | Balance |
| Example 2 | | | | | | | | | | | | |
| Comparative | 30 | / | 28.5 | / | 1.5 | 0.3 | 0.4 | / | 0.1 | 0.5 | 0.99 | Balance |
| Example 3 | | | | | | | | | | | | |
| Comparative | 32 | / | 30.5 | / | 1.5 | 0.4 | 0.6 | / | 0 | 1 | 1.05 | Balance |
| Example 4 | | | | | | | | | | | | |
| Comparative | 30 | / | 28.5 | / | 1.5 | 0.2 | 0.6 | / | 0.2 | 1 | 0.93 | Balance |
| Example 5 | | | | | | | | | | | | |
| Comparative | 29.5 | / | 28 | / | 1.5 | 0.4 | 0.6 | / | 0.2 | 1 | 0.9 | Balance |
| Example 6 | | | | | | | | | | | | |
| Comparative | 32 | / | 30.5 | / | 1.5 | 0.35 | 0.45 | / | 0 | 1.8 | 1.1 | Balance |
| Example 7 | | | | | | | | | | | | |

Note:
R refers to the total rare earth content, and specifically, refers to the total content of Nd, PrNd, Tb and Dy.

TABLE 2
Composition of R-T-B series permanent magnet material II and contents (wt. %)

| | | | | | | | | | | | | | (Fe + | |
|---|---|---|---|---|---|---|---|---|---|---|---|---|---|---|
| No. | R | Nd | PrNd | Tb | Dy | Cu | Al | Ga | Nb | Co | B | Fe | Co)/B | B/X |
| Example 1 | 30.5 | / | 30.2 | 0.3 | / | 0.3 | 0.5 | / | 0.1 | 0.5 | 0.97 | Balance | 13.69 | 3.9 |
| Example 2 | 30.5 | / | 29.5 | / | 1 | 0.5 | 0.7 | / | 0.25 | 0.5 | 1.03 | Balance | 12.59 | 2.8 |
| Example 3 | 31.5 | / | 30 | / | 1.5 | 0.4 | 0.6 | / | 0.2 | 1 | 0.99 | Balance | 12.96 | 3.2 |
| Example 4 | 31 | / | 30 | / | 1 | 0.35 | 0.51 | / | 0.15 | 1.5 | 1 | Balance | 12.95 | 3.8 |
| Example 5 | 32 | 30.5 | / | / | 1.5 | 0.45 | 0.65 | / | 0.12 | 1.2 | 0.98 | Balance | 12.99 | 2.9 |
| Example 6 | 31.5 | / | 30 | / | 1.5 | 0.2 | 0.6 | / | 0.2 | 1 | 0.99 | Balance | 13.00 | 3.6 |
| Example 7 | 31.5 | / | 30 | / | 1.5 | 0.5 | 0.4 | / | 0.2 | 1 | 0.99 | Balance | 12.98 | 4.0 |
| Example 8 | 31.5 | / | 30 | / | 1.5 | 0.2 | 0.8 | / | 0.2 | 1 | 0.99 | Balance | 12.96 | 2.8 |
| Example 9 | 31.5 | / | 30 | / | 1.5 | 0.4 | 0.4 | 0.3 | 0.2 | 1 | 0.99 | Balance | 12.94 | 3.6 |
| Comparative | 33.5 | / | 32 | / | 1.5 | 0.3 | 0.8 | / | 0.1 | 0.5 | 1.03 | Balance | 12.07 | 2.8 |
| Example 1 | | | | | | | | | | | | | | |
| Comparative | 29.5 | / | 28 | / | 1.5 | 0.25 | 0.4 | / | 0.3 | 0.4 | 0.97 | Balance | 13.68 | 4.8 |
| Example 2 | | | | | | | | | | | | | | |
| Comparative | 30 | / | 28.5 | / | 1.5 | 0.3 | 0.4 | / | 0.1 | 0.5 | 0.99 | Balance | 13.33 | 4.7 |
| Example 3 | | | | | | | | | | | | | | |
| Comparative | 32 | / | 30.5 | / | 1.5 | 0.4 | 0.6 | / | 0 | 1 | 1.05 | Balance | 12.15 | 3.4 |
| Example 4 | | | | | | | | | | | | | | |
| Comparative | 30 | / | 28.5 | / | 1.5 | 0.2 | 0.6 | / | 0.2 | 1 | 0.93 | Balance | 14.16 | 3.4 |
| Example 5 | | | | | | | | | | | | | | |
| Comparative | 29.5 | / | 28 | / | 1.5 | 0.4 | 0.6 | / | 0.2 | 1 | 0.9 | Balance | 14.7 | 2.9 |
| Example 6 | | | | | | | | | | | | | | |
| Comparative | 32 | / | 30.5 | / | 1.5 | 0.35 | 0.45 | / | 0 | 1.8 | 1.1 | Balance | 11.62 | 4.6 |
| Example 7 | | | | | | | | | | | | | | |

Note:
R refers to the total rare earth content, and specifically, refers to the total content of Nd, PrNd, Tb and Dy.

The preparation method for the R-T-B series sintered magnets in Examples 2-9 and Comparative Examples 1-7 was as follows:

(1) Smelting process: According to the formula shown in Table 1, the prepared raw materials were placed in a crucible made of aluminum oxide, and vacuum smelting was carried out in a high-frequency vacuum induction smelting furnace in a vacuum of 5×10⁻² Pa at a temperature of 1500° C. or lower.

(2) Casting process: Ar gas was introduced into the smelting furnace after vacuum smelting to make the gas pressure reach 55,000 Pa, casting was then carried out, and a quenched alloy was obtained at a cooling rate of 10² to 10⁴° C./sec.

(3) Hydrogen-decrepitation series pulverization process: A hydrogen decrepitation furnace, in which the quenched alloy was placed, was evacuated at room temperature, hydrogen with a purity of 99.9% was then introduced into the hydrogen decrepitation furnace, and the hydrogen pressure was maintained at 0.15 MPa; after full hydrogen absorption, the furnace was heated up while being evacuated, and full dehydrogenation was carried out; and after cooling, a powder pulverized by hydrogen decrepitation was taken out.

(4) Micro-pulverization process: The powder pulverized by hydrogen decrepitation was subjected to jet mill pulverization for 3 hours in a nitrogen atmosphere with an oxidizing gas content of 100 ppm or less under the condition of a pulverization chamber pressure of 0.38 MPa to obtain a fine powder. The oxidizing gas referred to oxygen or moisture.

(5) Zinc stearate was added to the powder resulting from jet mill pulverization in an amount of 0.12% by weight of the mixed powder, and then fully mixed by means of a V-type mixer.

(6) Magnetic field forming process: The above-mentioned powder, to which zinc stearate had been added, was subjected to primary formation into a cube with a side length of 25 mm by means of a right-angle alignment magnetic field forming machine in a 1.6 T alignment magnetic field at a forming pressure of 0.35 ton/cm², and after the primary formation, the powder was demagnetized in a 0.2 T magnetic field. The formed body resulting from primary formation was sealed so that it did not come into contact with air, and secondary formation was then carried out at a pressure of 1.3 ton/cm² using a secondary formation machine (an isostatic pressing machine).

(7) Sintering process: Each formed body was moved to a sintering furnace for sintering in a vacuum of 5×10⁻³ Pa and at temperatures of 300° C. and 600° C., each for 1 hour, and then for sintering at a temperature of 1040° C. for 2 hours, Ar gas was then introduced to make the gas pressure reach 0.1 MPa, and the formed body was then cooled to room temperature to obtain R-T-B series permanent magnet material II.

(8) Grain boundary diffusion treatment process: The metal Dy and R-T-B series permanent magnet material II were placed in a furnace and heated at a high temperature, such that the metal Dy was evaporated at the high temperature, deposited on the surface of the magnet under the induction of a foreign rare gas, and diffused into the interior of the magnet along the grain boundaries.

(9) Heat treatment process: The sintered body was heat treated for 3 hours in high-purity Ar gas at a temperature of 500° C., then cooled to room temperature, and then taken out to obtain R-T-B series permanent magnet material I.

The preparation method for the R-T-B series sintered magnet in Example 1 was as follows:

The NdFeB sintered magnet of Example 1 was prepared according to the formula shown in Table 1 and the preparation process of Example 2, except that during the grain boundary diffusion process, a metal with the element Tb attached was sputtered on the surface of the magnet.

### Effect Example

The magnetic performance, mechanical properties and compositions of the R-T-B series sintered magnets prepared in Examples 1-9 and Comparative Examples 1-7, including the sintered magnets before grain boundary diffusion (i.e. R-T-B series permanent magnet material II) and the sintered magnets after grain boundary diffusion (R-T-B series permanent magnet material I) were respectively measured, and the phase compositions of the magnets thereof were observed by FE-EPMA.

(1) The compositions of R-T-B series permanent magnet material I were measured using a high-frequency inductively coupled plasma optical emission spectrometer (ICP-OES), wherein the R₆T₁₃X phase was detected according to FE-EPMA testing. Table 3 below showed the composition test results.

TABLE 3
Composition of R-T-B series permanent magnet material I and contents (wt. %)

| | | | | | | | | | | | | | (Fe + | R₆T₁₃X | |
|---|---|---|---|---|---|---|---|---|---|---|---|---|---|---|---|
| No. | R | Nd | PrNd | Tb | Dy | Cu | Al | Ga | Nb | Co | B | Fe | Co)/B | generated? | B/X |
| Example 1 | 31 | / | 30.2 | 0.3 | / | 0.3 | 0.5 | / | 0.1 | 0.5 | 0.97 | 66.63 | 13.39 | Yes | 3.9 |
| Example 2 | 31 | / | 29.5 | / | 1.5 | 0.5 | 0.7 | / | 0.25 | 0.5 | 1.03 | 66.02 | 12.5 | Yes | 2.8 |
| Example 3 | 32 | / | 30 | / | 2 | 0.4 | 0.6 | / | 0.2 | 1 | 0.99 | 64.81 | 12.86 | Yes | 3.2 |
| Example 4 | 31.5 | / | 30 | / | 1.5 | 0.35 | 0.51 | / | 0.15 | 1.5 | 1 | 64.99 | 12.86 | Yes | 3.8 |
| Example 5 | 32.5 | 30.5 | / | / | 2 | 0.45 | 0.65 | / | 0.12 | 1.2 | 0.98 | 64.1 | 12.89 | Yes | 2.9 |
| Example 6 | 32 | / | 30 | / | 2 | 0.2 | 0.6 | / | 0.2 | 1 | 0.99 | 65.01 | 12.9 | Yes | 3.6 |
| Example 7 | 32 | / | 30 | / | 2 | 0.5 | 0.4 | / | 0.2 | 1 | 0.99 | 64.91 | 12.88 | Yes | 4.0 |
| Example 8 | 32 | / | 30 | / | 2 | 0.2 | 0.8 | / | 0.2 | 1 | 0.99 | 64.81 | 12.86 | Yes | 2.8 |
| Example 9 | 32 | / | 30 | / | 2 | 0.4 | 0.4 | 0.3 | 0.2 | 1 | 0.99 | 65.01 | 12.9 | Yes | 3.6 |
| Comparative | 34 | / | 32 | / | 2 | 0.3 | 0.8 | / | 0.1 | 0.5 | 1.03 | 63.27 | 11.98 | No | 2.8 |
| Example 1 | | | | | | | | | | | | | | | |
| Comparative | 30 | / | 28 | / | 2 | 0.25 | 0.4 | / | 0.3 | 0.4 | 0.97 | 67.68 | 13.58 | No | 4.8 |
| Example 2 | | | | | | | | | | | | | | | |
| Comparative | 30.5 | / | 28.5 | / | 2 | 0.3 | 0.4 | / | 0.1 | 0.5 | 0.99 | 67.21 | 13.24 | No | 4.7 |
| Example 3 | | | | | | | | | | | | | | | |
| Comparative | 32.5 | / | 30.5 | / | 2 | 0.4 | 0.6 | / | 0 | 1 | 1.05 | 64.45 | 12.06 | No | 3.4 |
| Example 4 | | | | | | | | | | | | | | | |
| Comparative | 30.5 | / | 28.5 | / | 2 | 0.2 | 0.6 | / | 0.2 | 1 | 0.93 | 66.57 | 14.05 | Yes | 3.4 |
| Example 5 | | | | | | | | | | | | | | | |
| Comparative | 30 | / | 28 | / | 2 | 0.4 | 0.6 | / | 0.2 | 1 | 0.9 | 66.9 | 14.59 | Yes | 2.9 |
| Example 6 | | | | | | | | | | | | | | | |
| Comparative | 32.5 | / | 30.5 | / | 2 | 0.35 | 0.45 | / | 0 | 1.8 | 1.1 | 63.8 | 11.53 | No | 4.6 |
| Example 7 | | | | | | | | | | | | | | | |

Note:
R refers to the total rare earth content, and specifically, refers to the total content of Nd, PrNd, Tb and Dy.

(2) Magnetic performance evaluation: The sintered magnet was tested for magnetic performance by NIM-10000H BH bulk rare earth permanent magnet nondestructive measurement system from The National Institute of Metrology of China.

Mechanical properties: The material was measured by a three-point bending method on a universal testing machine, the sample size was 45 mm×10 mm×3 mm, and the measured flexural strength was the fracture strength at a fracture along the direction parallel to the magnetic field orientation.

Table 4 below showed the test results of magnetic performance and mechanical properties.

TABLE 4
Performance of R-T-B series permanent magnet material I

| | | | | | Flexural |
|---|---|---|---|---|---|
| | Br | Hej | BHmax | | strength |
| No. | (kGs) | (kOe) | (MGOe) | BHH | (Mpa) |
| Example 1 | 13.53 | 28.2 | 44.4 | 72.6 | 378 |
| Example 2 | 13.51 | 25.5 | 44.3 | 69.8 | 386 |
| Example 3 | 13.31 | 26.5 | 43.0 | 69.5 | 398 |
| Example 4 | 13.42 | 25.2 | 43.7 | 68.9 | 385 |
| Example 5 | 13.24 | 26.5 | 42.5 | 69.0 | 402 |
| Example 6 | 13.29 | 25.6 | 42.8 | 68.4 | 392 |
| Example 7 | 13.32 | 25.1 | 43.0 | 68.1 | 395 |
| Example 8 | 13.28 | 26.5 | 42.8 | 69.3 | 389 |
| Example 9 | 13.29 | 25.8 | 42.8 | 68.6 | 384 |
| Comparative | 12.55 | 26 | 38.2 | 64.2 | 348 |
| Example 1 | | | | | |
| Comparative | 13.52 | 23.2 | 44.3 | 67.5 | 298 |
| Example 2 | | | | | |
| Comparative | 13.56 | 23.5 | 44.6 | 68.1 | 322 |
| Example 3 | | | | | |
| Comparative | 13.14 | 25 | 41.9 | 66.9 | 343 |
| Example 4 | | | | | |
| Comparative | 13.58 | 25.5 | 44.7 | 70.2 | 315 |
| Example 5 | | | | | |
| Comparative | 13.72 | 25.5 | 45.6 | 71.1 | 296 |
| Example 6 | | | | | |
| Comparative | 13.01 | 25 | 41.0 | 66.0 | 324 |
| Example 7 | | | | | |

As can be seen from Table 4,

1) the R-T-B series permanent magnet material I of the present application has a good magnetic performance, i.e. Br≥13.20 kGs, and Hcj≥25.1 kOe, indicating that the Br and Hcj are both improved; in addition, the maximum energy product ≥42.5 MGOe (Examples 1-9);
2) based on the formula of the present application, neither increasing the contents of R and Al nor reducing the contents of R and Al can result in the generation of the R₆T₁₃X phase, and the magnetic performance and flexural strength of R-T-B series permanent magnet material I both decrease (Comparative Examples 1 and 3);
3) based on the formula of the present application, given that the content of B is adjusted to a conventional content, if the contents of the other components are not within the ranges defined in the present application, the R₆T₁₃X phase may also not be generated, and the magnetic performance and flexural strength of R-T-B series permanent magnet material I both decrease (Comparative Example 2); and
4) based on the formula of the present application, given that the ratios of (Fe+Co)/B and B/X cannot be guaranteed to be within the ranges defined in the present application, even if the R₆T₁₃X phase is generated, the magnetic performance and flexural strength of R-T-B series permanent magnet material I cannot be both improved (Comparative Examples 4-7).

(3) FE-EPMA detection: A vertical alignment plane of the sintered magnet was polished, and tested by means of a field emission-electron probe micro-analyser (FE-EPMA) (JEOL, 8530F). A backscattering image was first photographed, and phases with different contrasts were then quantitatively analyzed to determine the phase composition, wherein the test conditions were an accelerating voltage of 15 kV and a probe beam current of 50 nA.

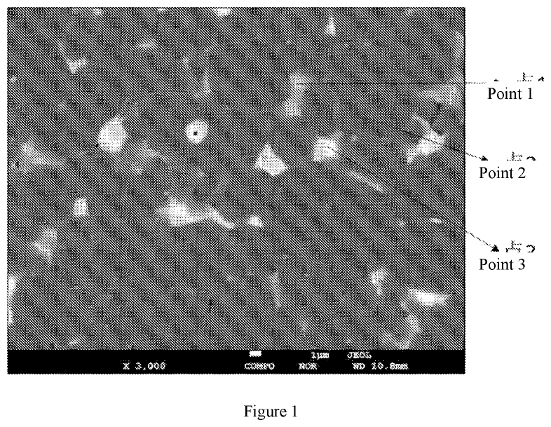

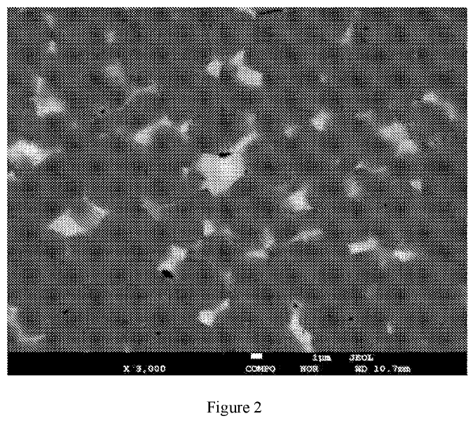

R-T-B series permanent magnet materials I prepared in Example 5 and Comparative Example 3 were tested by FE-EPMA, and the results were shown in Table 4, FIG. 1 and FIG. 2 below.

According to the FE-EPMA backscattering image of R-T-B series permanent magnet material I prepared in Example 5 (as shown in FIG. 1) in conjunction with the quantitative analysis results in Table 5, it can be known that the gray-white region 1 was the R₆-T₁₃-X phase, wherein R was Nd and Dy, T was mainly Fe and Co, and X was Al and Cu; the black region 2 was the main phase of R₂Fe₁₄B, and the bright white region 3 was other R-rich phases.

The FE-EPMA backscattering results of Comparative Example 3 lay in that the main phase in the black region and the bright white R-rich phase predominated, and no R₆-T₁₃-X phase was detected (FIG. 2).

TABLE 5

| | | | | | | | | Phase |
|---|---|---|---|---|---|---|---|---|
| (at %) | Nd | Dy | Fe | Co | Al | Cu | B | composition |
| Point 1 | 27.9 | 1.85 | 64.25 | 0.77 | 4.63 | 0.42 | 0 | R₆-T₁₃-X |
| Point 2 | 10.6 | 0.33 | 81.33 | 0.68 | 1.18 | 0.06 | 5.72 | R₂-T₁₄-B |

1. R-T-B series permanent magnet material I, wherein R-T-B series permanent magnet material I comprises R, T and X;
R is a rare earth element including at least Nd, and R includes RH, wherein RH is a heavy rare earth element, and RH includes at least one or more of Dy and Tb;
T includes at least Fe;
X is one or more of Al, Ga and Cu, and X necessarily includes Al;
R-T-B series permanent magnet material I satisfies the following relational expressions:
(1) an atomic ratio of (Fe+Co)/B of 12.5-13.5;
(2) an atomic ratio of B/X of 2.7-4.1;
R-T-B series permanent magnet material I comprises R₂T₁₄ B main phase crystalline grains, a two-grain boundary phase between two adjacent R₂T₁₄B main phase crystalline grains, and a rare-earth-rich phase, wherein the two-grain boundary phase and the rare-earth-rich phase comprise a phase composed of R₆T₁₃X.

2. R-T-B series permanent magnet material I according to claim 1, wherein R-T-B series permanent magnet material I comprises, by mass percentage,
31.0-32.5 wt. % of R, and R includes RH,
0.20-0.50 wt. % of Cu,
0.40-0.80 wt. % of Al,
0-0.30 wt. % of Ga,
0.10-0.25 wt. % of Nb,
0.5-2.0 wt. % of Co,
0.97-1.03 wt. % of B,
wherein wt. % refers to the mass percentage relative to R-T-B series permanent magnet material I;
R is a rare earth element including at least Nd, RH is a heavy rare earth element, and RH includes at least one or more of Dy and Tb.

3. R-T-B series permanent magnet material II, wherein R-T-B series permanent magnet material II comprises R, T and X;
R is a rare earth element including at least Nd, and R includes RH, wherein RH is a heavy rare earth element;
RH includes at least one or more of Dy and Tb;
T includes at least Fe;
X is one or more of Al, Ga and Cu, and X necessarily includes Al;
R-T-B series permanent magnet material II satisfies the following relational expressions:
(1) au atomic ratio of (Fe+Co)/B of 12.5-13.7;
(2) an atomic ratio of B/X of 2.8-4.0.

4. R-T-B series permanent magnet material II according to claim 3, wherein R-T-B series permanent magnet material II comprises, by mass percentage, the following components:
30.5-32 wt. % of R, and R includes RH,
0.20-0.50 wt. % of Cu,
0.40-0.80 wt. % of Al,
0-0.30 wt. % of Ga,
0.10-0.25 wt. % of Nb,
0.5-2.0 wt. % of Co, and
0.97-1.03 wt. % of B,
wherein wt. % refers to the mass percentage relative to R-T-B series permanent magnet material II;
R is a rare earth element including at least Nd;
RH is a heavy rare earth element, and RH includes at least one or more of Dy and Tb;
the balance is Fe and inevitable impurities.

5. A raw material composition for R-T-B series permanent magnet material II, comprising, by mass percentage, the following components:
30.5-32 wt. % of R, and R includes RH,
0.20-0.50 wt. % of Cu,
0.40-0.80 wt. % of Al,
0-0.30 wt.% of Ga,
0.10-0.25 wt. % of Nb,
0.5-2.0 wt. % of Co, and
0.97-1.03 wt. % of B,
wherein wt. % refers to the mass percentage relative to the raw material composition for R-T-B series permanent magnet material II;
R is a rare earth element including at least Nd;
RH is a heavy rare earth element, and RH includes at least one or more of Dy and Tb;
the balance is Fe and inevitable impurities.

6. A preparation method for R-T-B series permanent magnet material II, comprising the following step: subjecting a melt of the raw material composition for R-T-B series permanent magnet material II according to claim 5 to casting, crushing, pulverization forming, and sintering.

7. R-T-B series permanent magnet material II prepared by the preparation method according to claim 6.

8. A preparation method for R-T-B series permanent magnet material I, comprising subjecting the R-T-B series per lar ent magnet material II according to claim 3 to a grain boundary diffusion treatment.

9. R-T-B series permanent magnet material I prepared by the preparation method according to claim 8.

10. An application of n R-T-B series permanent magnet material as an electronic component, wherein
the R-T-B series permanent magnet material is R-T-B series permanent magnet material according to claim 1.

11. The R-T-B series permanent magnet material I according to claim 1, wherein, T includes Fe and Co;
or, the atomic ratio of (Fe+Co)/B is 12.8-13.39;
or, the atomic ratio of B/X is 2.8-4.

12. The R-T-B series permanent magnet material I according to claim 1, wherein, in the R₆-T₁₃-X phase, X is Al and Cu.

13. The R-T-B series permanent magnet material I according to claim 2, wherein, R further includes the element Pr;
or, the range of the content of R is 31.5-32.5 wt. %, wherein wt. % refers to the mass percentage relative to R-T-B series permanent magnet material I;
or, the range of the content of RH is 0.8-2.2 wt.%, wherein wt.% refers to the mass percentage relative to R-T-B series permanent magnet material I;
or, the range of the content of Nb is 0.1-0.2 wt. % or 0.12-0.25 wt. %, wherein wt. % refers to the mass percentage relative to R-T-B series permanent magnet material I;
or, the range of the content of Co is 0.5-1.5 wt. % or 1-2 wt. %, wherein wt. % refers to the mass percentage relative to R-T-B series permanent magnet material I;
or, the range of the content of B is 0.97-1 wt. % or 0.99-1.03 wt. %, wherein wt.% refers to the mass percentage relative to R-T-B series permanent magnet material I.

14. The R-T-B series permanent magnet material I according to claim 2, wherein, the range of the content of Cu is 0.2-0.4 wt. % or 0.3-0.5 wt. %, wherein wt. % refers to the mass percentage relative to R-T-B series permanent magnet material I;
or, the range of the content of Al is 0.4-0.6 wt. % or 0.5-0.8 wt. %, wherein wt. % refers to the mass percentage relative to R-T-B series permanent magnet material I;
or, the range of the content of Ga is 0 wt. % or (13 wt. %, wherein wt. % refers to the mass percentage relative to R-T-B series permanent magnet material I.

15. R-T-B series permanent magnet material II according to claim 3, wherein, T includes Fe and Co;
or, the atomic ratio of (Fe+Co)/B is 12.9-13;
or, the atomic ratio of B/X is 2.9-3.9.

16. R-T-B series permanent magnet material II according to claim 4, wherein, R further includes the element Pr;
or, the range of the content of R is 31-32 wt. %, wherein wt. % refers to the mass percentage relative to R-T-B series permanent magnet material II;
or, the range of the content of RH is 0.3-1.7 wt. %, wherein wt. % refers to the mass percentage relative to R-T-B series permanent magnet material II;
or, the range of the content of Nb is 0.1-0.2 wt. % or 0.12-0.25%, wherein wt. % refers to the mass percentage relative to R-T-B series permanent magnet material II;
or, the range of the content of Co is 0.5-1.5 wt.% or 1-2 wt. %, wherein wt. % refers to the mass percentage relative to R-T-B series permanent magnet material II;
or, the range of the content of B is 0.97-1 wt. % or 0.99-1.03 wt. %, wherein wt. % refers to the mass percentage relative to R-T-B series permanent magnet material II.

17. R-T-B series permanent magnet material II according to claim 4, wherein, the range of the content of Cu is 0.2-0.4 wt. % or 0.3-0.5 wt. %, wherein wt. % refers to the mass percentage relative to R-T-B series permanent magnet material II;
or, the range of the content of Al is 0.4-0.6 wt. % or 0.5-0.8 wt. %, wherein wt. % refers to the mass percentage relative to R-T-B series permanent magnet material II;
or, the range of the content of Ga is 0 wt. % or 0.3 wt. %, wherein wt. % refers to the mass percentage relative to R-T-B series permanent magnet material II.

18. The raw material composition for R-T-B series permanent magnet material II according to claim 5, wherein, the range of the content of R is 31-32 wt. %, wherein wt. % refers to the mass percentage relative to the raw material composition for R-T-B series permanent magnet material II;
or, the range of the content of RH is 0.3-1.7 wt. %, wherein wt. % refers to the mass percentage relative to the raw material composition for R-T-B series permanent magnet material II;
or, the range of the content of Nb is 0.1-112 wt. % or 0.12-0.25 wherein wt. % refers to the mass percentage relative to the raw material composition for R-T-B series permanent magnet material II;
or, the range of the content of Co is 0.5-1.5 wt. % or 1-2 wt. %, wherein wt. % refers to the mass percentage relative to the raw material composition for R-T-B series permanent magnet material II;
or, the range of the content of B is 0.97-1 wt. % or 0.99-1.03 wt. %, wherein wt. % refers to the mass percentage relative to the raw material composition for R-T-B series permanent magnet material II.

19. The raw material composition for R-T-B series permanent magnet material II according to claim 5, wherein, the range of the content of Cu is 0.2-0.4 wt. % or 0.3-0.5 wt. %, wherein wt. % refers to the mass percentage relative to the raw material composition for R-T-B series permanent magnet material II;
or, the range of the content of Al is 0.4-0.6 wt. % or 0.5-0.8 wt.%, wherein wt. % refers to the mass percentage relative to the raw material composition for R-T-B series permanent magnet material II;
or, the range of the content of Ga is 0 wt. % or 0.3 wt. %, wherein wt. % refers to the mass percentage relative to the raw material composition for R-T-B series permanent magnet material II.

20. An application of an R-T-B series permanent magnet material as an electronic component, wherein, the R-T-B series permanent magnet material is R-T-B series permanent magnet material II according to claim 3.
